(19) United States
(12) Patent Application Publication
(10) Pub. No.: US 2021/0043078 A1
(43) Pub. Date: Feb. 11, 2021

(54) RAPID PASSING METHOD AND DEVICE FOR TARGET VEHICLE

(71) Applicants: Fuzhou BOE Optoelectronics Technology Co., Ltd., Fuzhou, Fujian (CN); BOE Technology Group Co., Ltd., Beijing (CN)

(72) Inventors: Qifei CHEN, Beijing (CN); Kun LU, Beijing (CN); Xing ZHOU, Beijing (CN); Xiaozhe ZHANG, Beijing (CN); Ling BAI, Beijing (CN); Di XU, Beijing (CN); Dongliang XU, Beijing (CN); Liangliang REN, Beijing (CN); Xiaofeng LIU, Beijing (CN); Shan LU, Beijing (CN); Jingzhou LU, Beijing (CN); Guannan SONG, Beijing (CN); Huaping MA, Beijing (CN)

(21) Appl. No.: 16/650,968

(22) PCT Filed: Mar. 22, 2019
(86) PCT No.: PCT/CN2019/079324

§ 371 Date: Mar. 26, 2020

(51) Int. Cl. G08G 1/081; G08G 1/01; G08G 1/087

(52) U.S. Cl. CPC G08G 1/081; G08G 1/087; G08G 1/0145

(57) ABSTRACT

The present disclosure provides a rapid passing method and device for a target vehicle. The rapid passing method for the target vehicle includes: determining a passing route of the target vehicle according to a place where the target vehicle is located and a destination; acquiring position information of the target vehicle in real time; and controlling lane indicating devices in the passing route to indicate a special-purpose lane used by the target vehicle in the passing route according to the real-time position information and the passing route of the target vehicle, and controlling traffic lights to indicate vehicles disturbing passing of the target vehicle to stop driving when the target vehicle passes through an intersection.

### CROSS-REFERENCE TO RELATED APPLICATIONS

This application is a National Stage of International Application No. PCT/CN2019/079324, filed Mar. 22, 2019, which is hereby incorporated by reference in its entirety.

### FIELD

The present disclosure relates to the technical field of route planning and in particular to a rapid passing method and device for a target vehicle.

### BACKGROUND

Too many vehicles on a road may result in the problem of traffic congestion, in this way, the vehicles may not rapidly arrive at destinations, thereby affecting the affair handling efficiency.

### SUMMARY

A rapid passing method for a target vehicle, provided by an embodiment of the present disclosure, includes:
determining a passing route of the target vehicle according to a place where the target vehicle is located and a destination;
acquiring position information of the target vehicle in real time; and
controlling lane indicating devices in the passing route to indicate a special-purpose lane used by the target vehicle in the passing route according to real-time position information and the passing route of the target vehicle, and controlling traffic lights to indicate vehicles disturbing passing of the target vehicle to stop driving when the target vehicle passes through an intersection.

Optionally, in the embodiment of the present disclosure, the controlling the lane indicating devices in the passing route to indicate the special-purpose lane used by the target vehicle in the passing route includes:
controlling a lane indicating device in each of road sections to work according to the real-time position information of the target vehicle and a traffic flow of each of the road sections in the passing route so as to indicate the special-purpose lane.

Optionally, in the embodiment of the present disclosure, the controlling a lane indicating device in each of the road sections to work according to the real-time position information of the target vehicle and the traffic flow of each of the road sections in the passing route, includes:
determining arrival time when the target vehicle arrives at each of the road sections according to the real-time position information of the target vehicle;
determining guide time spent for clearing vehicles on the special-purpose lane in each of the road sections according to the traffic flow of each of the road sections in the passing route; and
controlling a lane indicating device in each of the road sections to start to work when the condition that t1+t3=t2 is met, wherein t1 represents for the guide time, t2 represents for the arrival time, and t3 represents for preset reserved time.

Optionally, in the embodiment of the present disclosure, the controlling the traffic lights to indicate the vehicles disturbing the passing of the target vehicle to stop driving when the target vehicle passes through the intersection specifically includes:
controlling the traffic lights in a traveling direction of the target vehicle to display one of a red light and a green light and controlling all traffic lights in a non-traveling direction of the target vehicle to display the red light when the target vehicle passes through the intersection to go straight.

Optionally, in the embodiment of the present disclosure, the controlling the traffic lights to indicate the vehicles disturbing the passing of the target vehicle to stop driving when the target vehicle passes through the intersection specifically includes:
controlling the traffic lights in the intersection to display a red light when the target vehicle passes through the intersection to turn left or right.

Optionally, in the embodiment of the present disclosure, when controlling the lane indicating devices in the passing route to indicate the special-purpose lane used by the target vehicle in the passing route, the method further includes:
controlling the lane indicating devices in the passing route to indicate applications of all driving lanes except the special-purpose lane used in the passing route.

Optionally, in the embodiment of the present disclosure, the lane indicating device includes a voice unit; and the controlling the lane indicating devices in the passing route to indicate the special-purpose lane used by the target vehicle in the passing route, includes:
controlling the voice unit in the lane indicating devices in the passing route to perform voice broadcasting on the special-purpose lane used by the target vehicle in the passing route.

Optionally, in the embodiment of the present disclosure, when controlling the voice unit in the lane indicating devices in the passing route to perform voice broadcasting on the special-purpose lane used by the target vehicle in the passing route, the method further includes:
controlling the voice unit in the lane indicating devices in the passing route to perform voice broadcasting on the applications of all the driving lanes except the special-purpose lane used in the passing route.

Optionally, in the embodiment of the present disclosure, the lane indicating devices includes a display unit; and controlling the lane indicating devices in the passing route to indicate the special-purpose lane used by the target vehicle in the passing route, includes:
controlling the display unit in the lane indicating devices in the passing route to display the special-purpose lane used by the target vehicle in the passing route.

Optionally, in the embodiment of the present disclosure, when controlling the display unit in the lane indicating devices in the passing route to display the special-purpose lane used by the target vehicle in the passing route, the method further includes:
controlling the display unit in the lane indicating devices in the passing route to display the applications of all the driving lanes except the special-purpose lane used in the passing route.

Optionally, in the embodiment of the present disclosure, the special-purpose lane is a driving lane with a same application in each of the road sections of the passing route.

Optionally, in the embodiment of the present disclosure, the driving lane includes a left-turn lane, a right-turn lane and a straight lane.

Optionally, in the embodiment of the present disclosure, the determining the passing route of the target vehicle, includes:
determining a passing route by which the driving time of the target vehicle is shortest according to the place where the target vehicle is located and the destination in combination with road condition information.

Optionally, in the embodiment of the present disclosure, the target vehicle includes at least one of an ambulance, a fire engine or a police car.

Accordingly, an embodiment of the present disclosure further provides a computer readable storage medium storing a computer program, wherein the computer program is executed by a processor to perform the above-mentioned rapid passing method for the target vehicle.

Accordingly, an embodiment of the present disclosure further provides a central control system including a memory, a processor and a computer program stored in the memory and capable of operating on the processor, the processor is configured to execute the computer program to perform the above-mentioned rapid passing method for the target vehicle.

Accordingly, an embodiment of the present disclosure further provides a rapid passing device for a target vehicle, including:
traffic lights;
the above-mentioned central control system; and
a lane indicating device configured to indicate a special-purpose lane used by the target vehicle in a passing route.

Optionally, in the embodiment of the present disclosure, the lane indicating device includes a display unit configured to display the special-purpose lane used by the target vehicle in the passing route.

Optionally, in the embodiment of the present disclosure, the display unit includes a plurality of display screens, wherein one of the display screens corresponds to one lane in a road section.

Optionally, in the embodiment of the present disclosure, the lane indicating device includes a voice unit configured to perform voice broadcasting on the special-purpose lane used by the target vehicle in the passing route.

Optionally, in the embodiment of the present disclosure, each of the traffic lights is integrally provided with the lane indicating device.

### BRIEF DESCRIPTION OF THE DRAWINGS

FIG. 1 is a flow diagram of a rapid passing method for a target vehicle, provided by an embodiment of the present disclosure;

FIG. 2 is a first schematic vertical structural diagram that a target vehicle provided by an embodiment of the present disclosure drives on a road;

FIG. 3 is a second schematic vertical structural diagram that the target vehicle provided by the embodiment of the present disclosure drives on the road;

FIG. 4 is a schematic structural diagram of a lane indicating device provided by an embodiment of the present disclosure;

FIG. 5 is a third schematic vertical structural diagram that the target vehicle provided by the embodiment of the present disclosure drives on the road;

FIG. 6 is a first schematic structural diagram of a lane indicating device and traffic lights provided by an embodiment of the present disclosure;

FIG. 7 is a second schematic structural diagram of the lane indicating device and the traffic lights provided by the embodiment of the present disclosure; and

FIG. 8 is a schematic structural diagram of a rapid passing device for a target vehicle, provided by an embodiment of the present disclosure.

### DETAILED DESCRIPTION OF THE EMBODIMENTS

In order to make objectives, technical solutions and advantages of the present disclosure clearer, specific implementations of a rapid passing method and device for a target vehicle, provided by embodiments of the present disclosure are described in detailed below with reference to accompanying drawings. It should be understood that preferred embodiments described below are merely intended to describe and explain the present disclosure, rather than to limit the present disclosure. Furthermore, the embodiments in the present disclosure and features in the embodiments may be combined with each other without conflicts. It should be noted that the size and shape of each drawing in the accompanying drawings are only intended to schematically describe the content of the present disclosure, rather than to reflect real scales. Moreover, same or similar numerals throughout indicate same or similar elements or elements with same or similar functions.

Too many vehicles on a road may result in the problem of traffic congestion, in this way, a vehicle such as an ambulance may not rapidly arrives at a place where a patient is located or the patient may not be taken to a hospital to be under treatment, and therefore, the patient may not be treated in time to fall into life danger.

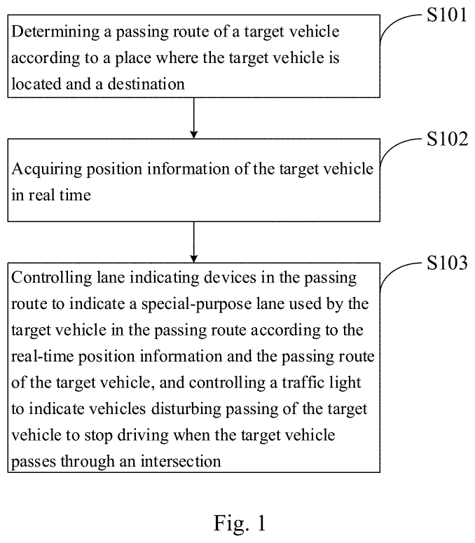

For this purpose, a rapid passing method for a target vehicle, provided by an embodiment of the present disclosure, as shown in FIG. 1, may include the following steps that:

S101, a passing route of a target vehicle is determined according to a place where the target vehicle is located and a destination;

S102, position information of the target vehicle is acquired in real time, wherein the position information of the target vehicle may be acquired by transmitting the position of the target vehicle after locating the position of the target vehicle by using a locating device arranged on the target vehicle. For example, communication with a locating device in an ambulance is performed, so that the locating device in the ambulance transmits a position signal itself every other a short time (such as 1 second or fractions of a second) to obtain the position information. The interval time is relatively short, and therefore, it may be regarded that the position information of the locating device in the ambulance is transmitted in real time. Or direct communication with an external navigation system may also be performed, so that the position of the target vehicle is directly located by the external navigation system and is then transmitted to obtain the position information;

S103, lane indicating devices in the passing route are controlled to indicate a special-purpose lane used by the target vehicle in the passing route according to the real-time position information and the passing route of the target vehicle, and traffic lights are controlled to indicate vehicles disturbing passing of the target vehicle to stop driving when the target vehicle passes through an intersection.

According to the rapid passing method for the target vehicle, provided by the embodiment of the present disclosure, the passing route of the target vehicle may be determined according to the place where the target vehicle is located and the destination. Moreover, the position information of the target vehicle is acquired in real time, in this way, the lane indicating devices in the passing route may be controlled to indicate the special-purpose lane used by the target vehicle in the passing route according to the real-time position information and the passing route of the target vehicle, thereby reminding vehicles driving on the special-purpose lane of performing avoidance to empty the special-purpose lane required to be passed by the target vehicle so as to reserve the special-purpose lane allowing the target vehicle to specially drive and further avoid the phenomenon that the target vehicle may not arrive at the destination in time due to road congestion. Moreover, the traffic lights are controlled to indicate the vehicles disturbing the passing of the target vehicle to stop driving when the target vehicle passes through the intersection so as to prevent ordinary vehicles intended to pass through the intersection from disturbing the driving of the target vehicle. Therefore, due to the adoption of the rapid passing method for the target vehicle, provided by the embodiment of the present disclosure, vehicles on a road may also be preferably hinted to avoid a lane special for driving of the target vehicle even if the situation of road congestion happens in the passing route, so that the driving speed of the target vehicle may be increased, and the time spent for arriving at the destination is greatly shortened.

Generally, when an emergency accident happens, corresponding vehicles are required to arrive at a place where the emergency accident happens to handle the accident. For example, a patient needs to be taken to a hospital through an ambulance when he suffers from an emergency disease. However, due to road congestion, it is possible that the ambulance may not rapidly arrive at the place where the patient is located or the patient may not be rapidly taken to the hospital to be under treatment, and therefore, the patient falls into life danger. For example, when a fire happens in a place, a fire engine is required to arrive in time to put out the fire. For another example, a police car is required to rush to a place where an accident happens to handle the happened accident in time. If the above-mentioned vehicles may not arrive in time due to road congestion, personal casualty may be caused. During specific implementation, in the embodiment of the present disclosure, the target vehicle may include at least one of the ambulance, the fire engine and the police car. Moreover, other vehicles except the above-mentioned target vehicle may be regarded as ordinary vehicles. Of course, emergency situations may also happen in an actual application, thus, one of the ordinary vehicles may also be directly determined as the target vehicle to handle an accident. For example, a traffic accident happens on a road, at the moment, in order to save the time and take a patient suffering from the traffic accident to a hospital, an ordinary vehicle may be used as the target vehicle to take the patient to the hospital to be under treatment.

Optionally, during specific implementation, the target vehicle may be set as an ambulance, in this way, due to the adoption of the rapid passing method for the target vehicle, provided by the embodiment of the present disclosure, vehicles on a road may also be preferably hinted to avoid a lane special for driving of the ambulance even if the situation of road congestion happens in the passing route, so that the driving speed of the ambulance is increased, and furthermore, the time spent for arriving at the destination (such as a place where a patient is located or a hospital) is greatly shortened so that more effective rescue is performed.

During specific implementation, the target vehicle may also be set as a fire engine, in this way, due to the adoption of the rapid passing method for the target vehicle, provided by the embodiment of the present disclosure, vehicles on a road may also be preferably hinted to avoid a lane special for driving of the fire engine even if the situation of road congestion happens in the passing route, so that the driving speed of the fire engine is increased, and furthermore, the time spent for arriving at the destination (such as a place where a fire happens) is greatly shortened so that more effective fire fighting and personnel rescue are performed.

During specific implementation, the target vehicle may also be set as a police car, in this way, due to the adoption of the rapid passing method for the target vehicle, provided by the embodiment of the present disclosure, vehicles on a road may also be preferably hinted to avoid a lane special for driving of the police car even if the situation of road congestion happens in the passing route, so that the driving speed of the police car is increased, and furthermore, the time spent for arriving at the destination (such as a place where an emergency accident happens) is greatly shortened so that the emergency accident is handled more effectively.

The rapid passing method for the target vehicle, provided by the embodiment of the present disclosure is detailed with an example in which the target vehicle is set as the ambulance. When the target vehicle is set as the fire engine and the police car, the rapid passing method for the target vehicle, provided by the embodiment of the present disclosure may refer to the embodiment of the ambulance, the descriptions thereof are omitted herein.

During specific implementation, in the embodiment of the present disclosure, the passing route of the target vehicle may be determined according to the place wherein the target vehicle is located and the destination. For example, a patient is taken to a hospital by calling an ambulance, if the ambulance does not receive the patient, but stops in the hospital, a position where the ambulance stops should be used as a place where the ambulance is located, and a position where the patient is located should be used as a destination of the ambulance, so that the passing route is determined. If the ambulance arrives at the place where the patient is located, the place where the patient is located may be used as the place where the ambulance is located, and the hospital may be used as the destination of the ambulance, so that the passing route is determined.

Further, in order to shorten the time spent by the ordinary vehicles avoiding the special-purpose lane, in the embodiment of the present disclosure, the step that the passing route of the target vehicle is determined may specifically includes: a passing route by which the driving time of the target vehicle is shortest is determined according to the place where the target vehicle is located and the destination in combination with road condition information. The road condition information may be the number of vehicles driving in a road section. For example, if the ambulance does not receive the patient, but stops in the hospital, a position where the ambulance stops should be used as a place where the ambulance is located, and a position where the patient is located should be used as a destination of the ambulance, so that the passing route by which the driving time of the ambulance is shortest is determined in combination with road condition information in each road section between the place and the destination, for example, according to road condition information at the moment when relatively few vehicles drive in each road section in the passing route, and further, effective rescue is performed.

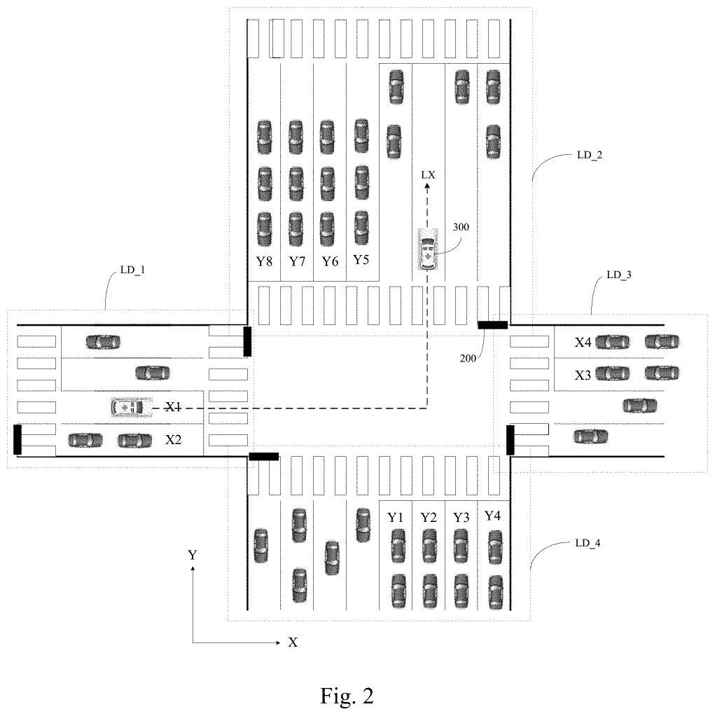

Generally, a road is provided with a plurality of driving lanes such as a left-turn lane, a right-turn lane and a straight lane for vehicle driving. For example, in actual life, the road may be provided with a two-way lane as shown in FIG. 2, namely a forward lane and a reverse lane in an X direction as well as a forward lane and a reverse lane in a Y direction. The forward lane in the X direction is provided with two driving lanes X1 and X2 for vehicle driving, the reverse lane in the X direction is also provided with two driving lanes X3 and X4 for vehicle driving. Specifically, the driving lane X1 may be used as a lane for two applications as the left-turn lane and the straight lane in a road section where the driving lane X1 is located, and the driving lane X2 may be used as a lane for two applications as the right-turn lane and the straight lane in a road section where the driving lane X2 is located. Similarly, the driving lane X3 may be used as a lane for two applications as the left-turn lane and the straight lane in a road section where the driving lane X3 is located, and the driving lane X4 may be used as a lane for two applications as the right-turn lane and the straight lane in a road section where the driving lane X4 is located. The forward lane in the Y direction is provided with four driving lanes Y1-Y4 for vehicle driving, and the reverse lane in the Y direction is also provided with four driving lanes Y5-Y8 for vehicle driving. The driving lane Y1 may be used as a lane for one application as the left-turn lane in a road section where the driving lane Y1 is located, each of the driving lanes Y2 and Y3 may be used as a lane for one application as the straight lane in each of road sections where the driving lanes Y2 and Y3 are located, and the driving lane Y4 may be used as a lane for one application as the right-turn lane in a road section where the driving lane Y4 is located. The driving lane Y5 may be used as a lane for one application as the left-turn lane in a road section where the driving lane Y5 is located, each of the driving lanes Y6 and Y7 may be used as a lane for one application as the straight lane in each of road sections where the driving lanes Y6 and Y7 are located, and the driving lane Y8 may be used as a lane for one application as the right-turn lane in a road section where the driving lane Y8 is located.

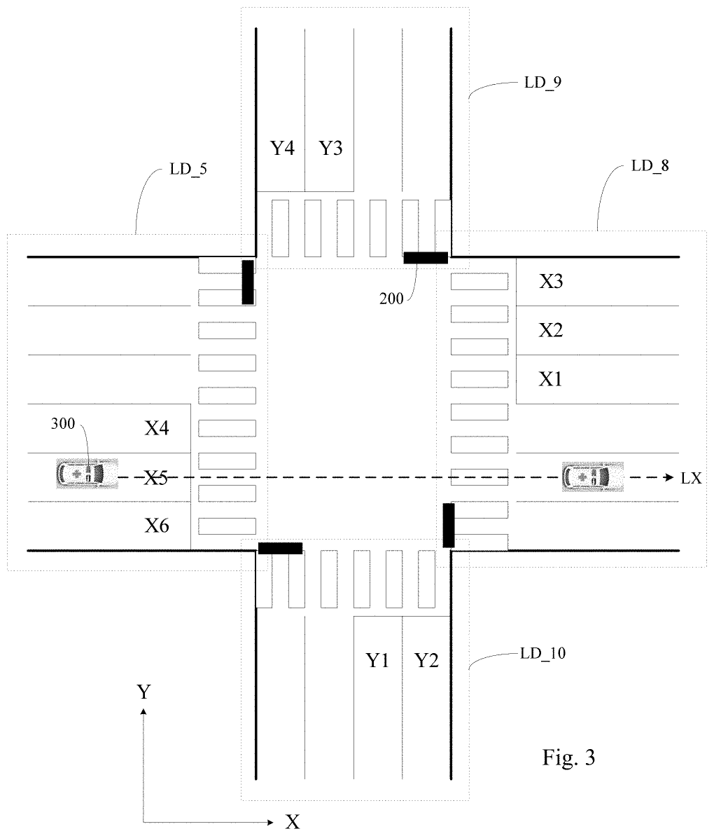

In actual life, a road may also be provided with a two-way lane as shown in FIG. 3, namely a forward lane and a reverse lane in an X direction as well as a forward lane and a reverse lane in a Y direction. The forward lane in the X direction is provided with three driving lanes X4-X6 for vehicle driving, the reverse lane in the X direction is also provided with three driving lanes X1-X3 for vehicle driving. The forward lane in the Y direction is provided with two driving lanes Y1-Y2 for vehicle driving, and the reverse lane in the Y direction is also provided with two driving lanes Y3-Y4 for vehicle driving. The driving lane X1 may be used as a lane for one application as the left-turn lane in a road section where the driving lane X1 is located, the driving lane X2 may be used as a lane for one application as the straight lane in a road section where the driving lane X2 is located, and the driving lane X3 may be used as a lane for one application as the right-turn lane in a road section where the driving lane X3 is located. The driving lane X4 may be used as a lane for one application as the left-turn lane in a road section where the driving lane X4 is located, the driving lane X5 may be used as a lane for one application as the straight lane in a road section where the driving lane X5 is located, and the driving lane X6 may be used as a lane for one application as the right-turn lane in a road section where the driving lane X6 is located. The driving lane Y1 may be used as a lane for two applications as the left-turn lane and the straight lanes in a road section where the driving lane Y1 is located, and the driving lane Y2 may be used as a lane for two applications as the right-turn lane and the straight lane in a road section where the driving lane Y2 is located. Similarly, the driving lane Y3 may be used as a lane for two applications as the left-turn lane and the straight lane in a road section where the driving lane Y3 is located, and the driving lane Y4 may be used as a lane for two applications as the right-turn lane and the straight lane in a road section where the driving lane Y4 is located.

In order to further shorten the time spent by the ordinary vehicles avoiding the special-purpose lane, during specific implementation, in the embodiment of the present disclosure, the special-purpose lane may be set as a driving lane with the same application in each of the road sections of the passing route. Further, the driving lane may be enabled to include a left-turn lane, a right-turn lane and a straight lane. For example, the special-purpose lane may be set as the left-turn lane in each of the road sections in the passing route. In this way, the left-turn lane in each of the road sections may merely be adopted as the special-purpose lane of the ambulance so as to be avoided by the remaining ordinary vehicles. Or the special-purpose lane may also be set as the straight lane in each of the road sections of the passing route. In this way, the straight lane in each of the road sections may merely be adopted as the special-purpose lane of the ambulance so as to be avoided by the remaining ordinary vehicles. Or the special-purpose lane may also be set as the right-turn lane in each of the road sections of the passing route. In this way, the right-turn lane in each of the road sections may merely be adopted as the special-purpose lane of the ambulance so as to be avoided by the remaining ordinary vehicles. Of course, in an actual application, which lane to be adopted is designed and determined according to an actual application environment, the descriptions thereof are omitted herein.

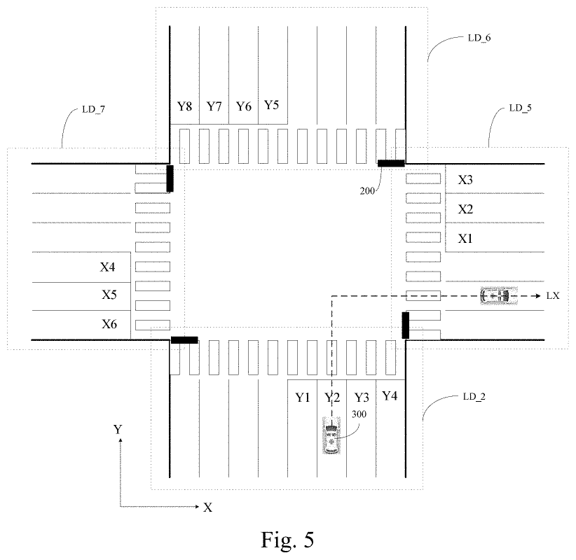

It should be noted that one road may be generally provided with a plurality of intersections, each of the intersections may be generally provided with traffic lights, and the road sections mentioned in the present disclosure mean those located between every two adjacent traffic lights in a road, such as road sections LD_1 and LD_2 in FIG. 2. Moreover, the road sections in a passing route LX, for example, may include the road sections LD_1 and LD_2 in FIG. 2, road sections LD_5 and LD_8 in FIG. 3 as well as road sections LD_2 and LD_5 in FIG. 5. Road sections LD_3 and LD_4 in FIG. 2, road sections LD_9 and LD 10 in FIG. 3 and road sections LD_6 and LD_7 in FIG. 5 are not road sections in the passing route LX. Moreover, the setting way of the traffic lights in the intersections is basically same as that in a related art and should be understood by those skilled in the art that the setting way is provided, the descriptions thereof are omitted herein, and the setting way should not be regarded as a limitation to the present disclosure.

During specific implementation, in the embodiment of the present disclosure, when the lane indicating devices in the passing route are controlled to indicate the special-purpose lane used by the target vehicle in the passing route, the rapid passing method may also include that: the lane indicating devices in the passing route are controlled to indicate applications of all driving lanes except the special-purpose lane used in the passing route. In this way, when the special-purpose lane is avoided, all the driving lanes except the special-purpose lane may be enabled to perform traffic driving or vehicle parking. For example, as shown in combination with FIG. 2, with the road sections LD_1 and LD_2 in the passing route LX of an ambulance as examples, the lane indicating devices can be controlled to indicate the driving lanes X1 and Y2 as special-purpose lanes used by the ambulance 300 in the passing route LX. Moreover, the lane indicating devices are also controlled to indicate an application of the driving lane X2 in the road section LD_1 to serve as an ordinary vehicle in the road section, for example, the driving lane X2 is indicated to serve as a right-turn lane and a straight lane. Furthermore, the lane indicating devices are controlled to indicate applications of the driving lanes Y1, Y3 and Y4 in the road section LD_2. For example, the driving lane Y1 is indicated to serve as a left-turn lane, the driving lane Y3 is indicated to serve as a straight lane, and the driving lane Y4 is indicated to serve as a right-turn lane.

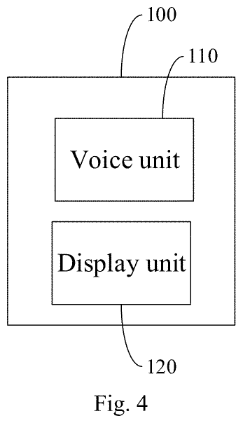

During specific implementation, as shown in FIG. 4, a lane indicating device 100 may include: a voice unit 110. In the embodiment of the present disclosure, the step that the lane indicating devices in the passing route are controlled to indicate the special-purpose lane used by the target vehicle in the passing route may specifically include that: the voice unit 110 in each of the lane indicating devices in the passing route is controlled to perform voice broadcasting on the special-purpose lane used by the target vehicle in the passing route. In this way, drivers in the ordinary vehicles in the passing route may be prompted through a sound to drive the vehicles to other lanes, so that the special-purpose lane of the ambulance is avoided, and a vacant special-purpose lane special for ambulance driving is reserved.

Further, during specific implementation, in the embodiment of the present disclosure, when the voice unit in each of the lane indicating devices in the passing route is controlled to perform voice broadcasting on the special-purpose lane used by the target vehicle in the passing route, the rapid passing method may further include that: the voice unit in each of the lane indicating devices in the passing route is controlled to perform voice broadcasting on the applications of all the driving lanes except the special-purpose lane used in the passing route. In this way, drivers in the ordinary vehicles in the passing route may be prompted through a sound to drive the vehicles to the driving lanes with the corresponding applications so as to normally drive or park, thereby avoiding the special-purpose lane of the ambulance.

During specific implementation, as shown in FIG. 4, the lane indicating device 100 may further include: a display unit 120. In the embodiment of the present disclosure, the step that the lane indicating devices in the passing route are controlled to indicate the special-purpose lane used by the target vehicle in the passing route may specifically include that: the display unit 120 in each of the lane indicating devices in the passing route is controlled to display the special-purpose lane used by the target vehicle in the passing route. In this way, drivers in the ordinary vehicles in the passing route may be prompted through displaying to drive the vehicles to other lanes, so that the special-purpose lane of the ambulance is avoided, and a vacant special-purpose lane special for ambulance driving is reserved.

Further, during specific implementation, in the embodiment of the present disclosure, when the display unit in each of the lane indicating devices in the passing route is controlled to display the special-purpose lane used by the target vehicle in the passing route, the rapid passing method may further include that: the display unit in each of the lane indicating devices in the passing route is controlled to display the applications of all the driving lanes except the special-purpose lane used in the passing route. In this way, drivers in the ordinary vehicles in the passing route may be prompted through displaying to drive the vehicles to the driving lanes with the corresponding applications so as to normally drive or park, thereby avoiding the special-purpose lane of the ambulance.

Further, during specific implementation, as shown in FIG. 4, the lane indicating device 100 may include both the voice unit 110 and the display unit 120. In this way, drivers in the ordinary vehicles in the passing route not only may be prompted through a sound, but also may be prompted through image display, so that the special-purpose lane of the ambulance is avoided, and a vacant special-purpose lane special for ambulance driving is reserved.

During specific implementation, in the embodiment of the present disclosure, each of the road sections may be provided with at least one of the lane indicating devices. For example, each of the road sections may be provided with one of the lane indicating devices, wherein the lane indicating devices may be arranged on middle positions of the road sections where the lane indicating devices are located, or in order to improve an integrality level, the lane indicating devices may be integrated with the traffic lights, so that one of the traffic lights 200 is integrally provided with one of the lane indicating devices 100, as shown in FIG. 5. Of course, the specific positions of the lane indicating devices may be designed and determined according to an actual application environment, the limitations thereof are omitted herein.

During specific implementation, in the embodiment of the present disclosure, the step that the lane indicating devices in the passing route are controlled to indicate the special-purpose lane used by the target vehicle in the passing route may specifically include that:
each lane indicating device in each of the road sections is controlled to work according to the real-time position information of the target vehicle and a traffic flow of each of the road sections in the passing route so as to indicate the special-purpose lane.

Further, during specific implementation, in the embodiment of the present disclosure, the step that each lane indicating device in each of the road sections is controlled to work according to the real-time position information of the target vehicle and the traffic flow of each of the road sections in the passing route may specifically include that:
the arrival time when the target vehicle arrives at each of the road sections is determined according to the real-time position information of the target vehicle. The arrival time of each of the road sections means the time spent by the target vehicle driving from a position where the target vehicle is located to a new road section to be arrived ahead. For example, as shown in combination with FIG. 2, the ambulance 300 drives on a certain position in the road section LD_1, and the time spent by the ambulance 300 from a position where the ambulance 300 is located in the road section LD_1 to the road section LD_2 through an intersection may be calculated according to a distance from the position to the road section LD_2.

Guide time spent for clearing vehicles on the special-purpose lane in each of the road sections is determined according to the traffic flow of each of the road sections in the passing route. The vehicles on the special-purpose lane may be guided to other lanes or other road sections.

Each lane indicating device in each of the road sections is controlled to start to work when the condition that t1+t3=t2 is met, wherein t1 represents for the guide time, t2 represents for the arrival time, and t3 represents for preset reserved time. In this way, the vehicles on the road section may normally drive when the ambulance does not enter a certain road section in the passing route. When the ambulance drives to a certain position and the critical condition that t1+t3=t2 is met, it means that the ambulance will arrive at the road section after driving for the time t3, and therefore, the lane indicating device in the road section is controlled to start to work, the lane indicating device in the road section is controlled in advance to work, and the vehicles on the special-purpose lane are guided in advance to avoid. Guiding the vehicles to avoid may result in delay, and therefore, the preset reserved time is set, in this way, the vehicle on the special-purpose lane may be effectively guided before the ambulance arrives. In an actual application, the preset reserved time may be designed and determined according to an actual application environment, the limitations thereof are omitted herein.

Generally, vehicles may turn left or turn right or go straight when passing through an intersection (such as a crossroad). In this way, a target vehicle may be disturbed by ordinary vehicles when passing through the intersection. Traffic regulations of the target vehicle are more relaxed than those of ordinary vehicles, and the target vehicle owns emergency privileges not available for the ordinary vehicles, such as a privilege of running a red light. During specific implementation, in the embodiment of the present disclosure, the step that the traffic lights are controlled to indicate the vehicles disturbing the passing of the target vehicle to stop driving when the target vehicle passes through the intersection may specifically include that: each traffic light in the intersection is controlled to display a red light when the target vehicle passes through the intersection to turn left or right. For example, as shown in combination with FIG. 2, each of the traffic lights 200 in the intersection may be controlled to display the red light when the ambulance 300 passes through the intersection to turn left. In this way, vehicles on the driving lane X2 in the road section LD_1 may stop driving, and vehicles on the driving lanes X3 and X4 in the road section LD_3 stop driving. Vehicles on the driving lanes Y5-Y8 in the road section LD_2 stop driving, and vehicles on the driving lanes Y1-Y4 in the road section LD_4 stop driving. In this way, the ordinary vehicles are prevented from disturbing the ambulance 300 when passing through the intersection. Or as shown in combination with FIG. 5, each of the traffic lights 200 in the intersection may be controlled to display the red light when the ambulance passes through the intersection to turn right. In this way, vehicles on the driving lanes Y5-Y8 in the road section LD_6 may stop driving, and vehicles on the driving lanes Y1, Y3 and Y4 in the road section LD_2 stop driving. Vehicles on the driving lanes X1-X3 in the road section LD_5 may stop driving, and vehicles on the driving lanes X4-X6 in the road section LD_7 stop driving. In this way, vehicles on each lane may stop driving, thereby preventing the ordinary vehicles from disturbing the normal diving of the ambulance 300 when passing through the intersection.

During specific implementation, in the embodiment of the present disclosure, the step that the traffic lights are controlled to indicate the vehicles disturbing the passing of the target vehicle to stop driving when the target vehicle passes through the intersection may specifically include that: the traffic lights in a traveling direction of the target vehicle may be controlled to display one of a red light and a green light and all the traffic lights in a non-traveling direction of the target vehicle may be controlled to display the red light when the target vehicle passes through the intersection to go straight. As shown in combination with FIG. 3, the traveling direction of the ambulance 300 is a direction pointed by an arrow of the route LX, namely a Y direction, and the non-traveling direction of the ambulance is a direction crossed with the direction pointed by the arrow of the route LX, such as an X direction pointed by an arrow vertical to the route LX. Two traffic lights 200 on a rod in the Y direction and two traffic lights 200 in the Y direction may be controlled to display the red light when the ambulance passes through the intersection to go straight, in this way, the ordinary vehicles on each of the driving lanes X1-X4, X6 and Y1-Y4 may stop driving when the ambulance passes, thereby preventing the ordinary vehicles from disturbing the normal diving of the ambulance when passing through the intersection. Or, two traffic lights 200 on a road in the Y direction may be controlled to display the red light when the ambulance passes through the intersection to go straight, in this way, the vehicles on the driving lanes Y1-Y4 may stop driving, thereby preventing the ordinary vehicles on the road in the Y direction from disturbing the normal diving of the ambulance when passing through the intersection. Moreover, two traffic lights 200 on the road in the X direction may display the green light, so that the ordinary vehicles on the road in the X direction may perform normal driving such as left-turn or right-turn. The ambulance 300 going straight may not be disturbed when the ordinary vehicles on the road in the X direction perform normal driving such as left-turn or right-turn, and therefore, the traffic driving efficiency of the ordinary vehicles may also be increased.

The implementation process of the rapid passing method for the target vehicle, provided by the present disclosure, is described below with an example in which the target vehicle is an ambulance and a patient is required to be taken to a hospital by using the ambulance in combination with FIG. 2 to FIG. 7. However, a reader should know that the specific process of the rapid passing method of the target vehicle is not limited herein.

The rapid passing method for the target vehicle, provided by the embodiment of the present disclosure, may include the steps as follows:

(1) a position where the ambulance is located is used as a place of the ambulance is located, the hospital is used as a destination, and a passing route by which the driving time of the ambulance arriving at the hospital is shortest is determined according to the above-mentioned place and destination as well as road condition information in each of road sections between the place and the destination, so that the passing route with the shortest time is used as an optimal route or a least congested route;

(2) A locating device in the ambulance transmits location information thereof every other 1 s so as to acquire position information of the ambulance in real time;

(3) The arrival time t3 when the ambulance arrives at each of the road sections is determined according to the real-time position information of the ambulance. As shown in combination with FIG. 2, the ambulance 300 drives on a certain position in a road section LD_1, and the time spent by the ambulance 300 from a position where the ambulance 300 is located in the road section LD_1 to a road section LD_2 through an intersection may be calculated according to a distance from the position to the road section LD_2. Other road sections are based on the same way, the descriptions thereof are omitted herein;

(4) Guide time t1 spent for guiding vehicles on a special-purpose lane in each of the road sections to other lanes or other road sections so as to clear ordinary vehicles on the special-purpose lane is determined according to a traffic flow of each of the road sections in a passing route LX;

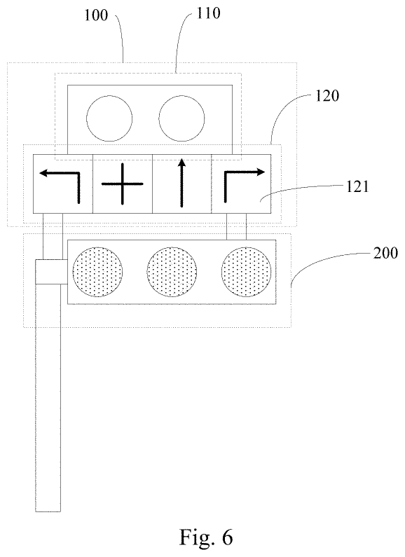

(5) As shown in combination with FIG. 2 and FIG. 6, when the condition that t1+t3=t2 is met, it means that the ambulance may arrive at the road section LD_2 from a certain road section (such as the road section LD_1, of course, the road section may also be other road sections in the passing route and needs to be designed and determined according to an actual application environment, the limitations thereof are omitted herein) after driving for the time t3, at the moment, a lane indicating device 100 in the road section LD_2 is controlled to start to work. A voice unit 110 is controlled to perform voice broadcasting and a display unit 120 is controlled to display to remind drivers in ordinary vehicles driving on lanes Y1-Y4 in the road section LD_2, at the moment, the driving lane Y1 is used as a left-turn lane for the ordinary vehicles, the driving lane Y2 is used as a special-purpose lane for the ambulance, the driving lane Y3 is used as a straight lane for the ordinary vehicles, and the driving lane Y4 is used as a right-turn lane for the ordinary vehicle. The ordinary vehicles on the driving lane Y2 in the road section LD_2 are guided to be cleared in advance in combination with traffic lights on the road section;

(6) As shown in combination with FIG. 2 and FIG. 6, four traffic lights 200 in the intersection may be controlled to display red lights when the ambulance 300 passes through the intersection as shown in FIG. 2 to turn left, so that vehicles on a driving lane X2 in the road section LD_1 may stop driving, and vehicles on driving lanes X3 and X4 in a road section LD_3 may stop driving. Vehicles on driving lanes Y5-Y8 in the road section LD_2 may stop driving, and vehicles on driving lanes Y1-Y4 in a road section LD_4 may stop driving, thereby preventing the ordinary vehicles from disturbing driving of the ambulance 300 when passing through the intersection;

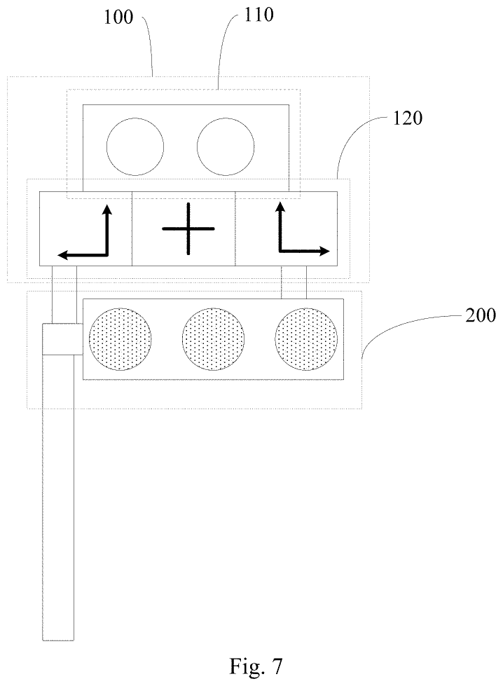

(7) As shown in combination with FIG. 5 and FIG. 7, when the condition that t1+t3=t2 is met, it means that the ambulance may arrive at a road section LD_5 from a certain road section (such as the road section LD_2, of course, the road section may also be other road sections in the passing route and needs to be designed and determined according to an actual application environment, the limitations thereof are omitted herein) after driving for the time t3, at the moment, a lane indicating device 100 in the road section LD_5 is controlled to start to work. A voice unit 110 is controlled to perform voice broadcasting and a display unit 120 is controlled to display to remind drivers in ordinary vehicles driving on lanes X4-X6 in the road section LD_5, at the moment, the driving lane X4 is used as a left-turn lane and a straight lane for the ordinary vehicles, the driving lane X5 is used as a special-purpose lane for the ambulance, and the driving lane X6 is used as a right-turn lane and a straight lane for the ordinary vehicles. Moreover, the ordinary vehicles on the driving lane X5 in the road section LD_5 are guided to be cleared in advance in combination with traffic lights on the road section;

(8) As shown in combination with FIG. 5 and FIG. 7, four traffic lights 200 in the intersection may be controlled to display red lights when the ambulance 300 passes through the intersection as shown in FIG. 5 to turn right, so that vehicles on driving lanes X4-X6 in a road section LD_7 may stop driving, and vehicles on driving lanes X1-X3 in the road section LD_5 may stop driving. Vehicles on driving lanes Y1-Y4 in the road section LD_2 may stop driving, and vehicles on driving lanes Y5-Y8 in a road section LD_6 may stop driving, thereby preventing the ordinary vehicles from disturbing driving of the ambulance 300 when passing through the intersection;

(9) As shown in combination with FIG. 3 and FIG. 7, when the condition that t1+t3=t2 is met, it means that the ambulance may arrive at a road section LD_8 from a certain road section (such as the road section LD_5, of course, the road section may also be other road sections and needs to be designed and determined according to an actual application environment, the limitations thereof are omitted herein) after driving for the time t3, at the moment, a lane indicating device 100 in the road section LD_8 is controlled to start to work. A voice unit 110 is controlled to perform voice broadcasting and a display unit 120 is controlled to display to remind drivers in ordinary vehicles driving on lanes X4-X5 in the road section LD_8, at the moment, the driving lane X4 is used as a left-turn lane and a straight lane for the ordinary vehicles, the driving lane X5 is used as a special-purpose lane for the ambulance, and the driving lane X6 is used as a right-turn lane and a straight lane for the ordinary vehicles. Moreover, the ordinary vehicles on the driving lane X5 in the road section LD_8 are guided to be cleared in advance in combination with traffic lights on the road section;

(10) As shown in combination with FIG. 3 and FIG. 7, two traffic lights 200 on a road in a Y direction may be controlled to display red lights when the ambulance 300 passes through the intersection as shown in FIG. 3 to go straight, so that vehicles on the driving lanes Y1-Y4 may stop driving, thereby preventing the ordinary vehicles on the road in the Y direction from disturbing the normal driving of the ambulance when passing through the intersection. Moreover, two traffic lights 200 on a road in an X direction may be controlled to display green lights, so that the ordinary vehicles on the road in the X direction may perform normal driving such as left-turn or right-turn.

Later, a working process that the ambulance arrives at other road sections in the passing route and passes through the intersection may refer to the steps in the above-mentioned steps (5)-(10), so that the ambulance may rapid arrives at the hospital.

Based on the same inventive concept, an embodiment of the present disclosure further provides a computer readable storage medium storing a computer program, wherein the steps of the above-mentioned rapid passing method for the target vehicle, provided by the embodiment of the present disclosure, are implemented when the program is executed by a processor. Further, the computer readable storage medium includes, but is not limited to a disk memory, a CD-ROM, an optical memory and the like.

Based on the same inventive concept, an embodiment of the present disclosure further provides a central control system including a memory, a processor and a computer program stored in the memory and capable of operating on the processor, the steps of the above-mentioned rapid passing method for the target vehicle, provided by the embodiment of the present disclosure, are implemented when the computer program is executed by the processor. It should be understood by the skilled in the art that the central control system provided by the present disclosure may adopt a form of a full-hardware embodiment, a full-software embodiment or a software and hardware combination embodiment.

During specific implementation, the central control system provided by the present disclosure may include:
a route unit configured to determine a passing route of a target vehicle according to a place where the target vehicle is located and a destination;
a position information unit configured to acquire position information of the target vehicle in real time; and
a command and control unit configured to control lane indicating devices in the passing route to indicate a special-purpose lane used by the target vehicle in the passing route according to the real-time position information and the passing route of the target vehicle and control traffic lights to indicate vehicles disturbing the passing of the target vehicle to stop driving when the target vehicle passes through an intersection.

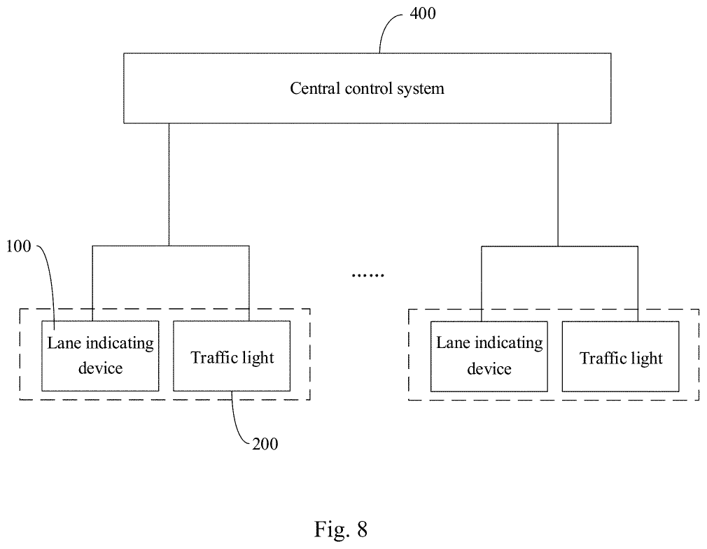

Based on the same inventive concept, an embodiment of the present disclosure further provides a rapid passing device for a target vehicle, as shown in FIG. 8, the rapid passing device may include: traffic lights 200, a central control system 400 provided by the embodiment of the present disclosure and lane indicating devices 100. The lane indicating devices 100 are configured to indicate a special-purpose lane used by the target vehicle in a passing route. Specifically, the central control system may control each of the traffic lights 200 and each of the lane indicating devices 100.

During specific implementation, in the embodiment of the present disclosure, as shown in FIG. 4, FIG. 6 and FIG. 7, each of the lane indicating devices 100 may include a display unit 120. The display unit 120 may be configured to display the special-purpose lane used by the target vehicle in the passing route. Further, the display unit 120 is further configured to display applications of all driving lanes except the special-purpose lane in the passing route. In an actual application, the display unit 120 may be configured to receive a signal output by the central control system and perform displaying according to the received signal.

During specific implementation, in the embodiment of the present disclosure, as shown in FIG. 6 and FIG. 7, the display unit 120 may include a plurality of display screens 121, wherein one of the display screens corresponds to one lane in a road section. For example, as shown in combination with FIG. 2 and FIG. 6, a driving lane Y1 corresponds to a first display screen 121, a driving lane Y2 corresponds to a second display screen 121, a driving lane Y3 corresponds to a third display screen 121, and a driving lane Y4 corresponds to a fourth display screen 121.

During specific implementation, in the embodiment of the present disclosure, as shown in FIG. 4, FIG. 6 and FIG. 7, each of the lane indicating devices 100 may include a voice unit 110. The voice unit 110 may be configured to perform voice broadcasting on the special-purpose lane used by the target vehicle in the passing route. Further, the voice unit 110 is further configured to perform voice broadcasting on the applications of all the driving lanes except the special-purpose lane in the passing route. In an actual application, the voice unit 110 may be configured to receive the signal output by the central control system and perform voice broadcasting according to the received signal.

During specific implementation, in the embodiment of the present disclosure, the voice unit may include a loudspeaker.

Further, during specific implementation, in the embodiment of the present disclosure, as shown in FIG. 4, FIG. 6 and FIG. 7, each of the lane indicating devices 100 may include both the voice unit 110 and the display unit 120.

During specific implementation, in the embodiment of the present disclosure, as shown in FIG. 6 and FIG. 7, each of the traffic lights 200 may be integrally provided with one of the lane indicating devices 100, so that an integration level is improved.

During specific implementation, the position information unit in the central control system and the lane indicating devices may be integrated to perform communication with the target vehicle in time so as to acquire the real-time position information of the target vehicle.

During specific implementation, communication between the position information unit and the command and control unit may be performed in a wireless or wired way.

According to the rapid passing method and device for the target vehicle, provided by the embodiments of the present disclosure, the passing route of the target vehicle may be determined according to the place where the target vehicle is located and the destination. Moreover, the position information of the target vehicle is acquired in real time, in this way, the lane indicating devices in the passing route may be controlled to indicate the special-purpose lane used by the target vehicle in the passing route according to the real-time position information and the passing route of the target vehicle, thereby reminding vehicles driving on the special-purpose lane of performing avoidance to empty the special-purpose lane required to be passed by the target vehicle so as to reserve the special-purpose lane allowing the target vehicle to specially drive and further avoid the phenomenon that the target vehicle may not arrive at the destination in time due to road congestion. Moreover, the traffic lights are controlled to indicate the vehicles disturbing the passing of the target vehicle to stop driving when the target vehicle passes through the intersection so as to prevent ordinary vehicles intended to pass through the intersection from disturbing the driving of the target vehicle.

Obviously, the skilled in the art can make various alterations and variations on the embodiments of the present disclosure without departing from the spirit and scope of the embodiments of the present disclosure. In this way, if these alterations and variations of the embodiments of the present disclosure fall within the scopes of the claims and the equivalent technologies of the present disclosure, the present disclosure is also intended to include the alterations and variations.

1. A rapid passing method for a target vehicle, comprising:
determining a passing route of the target vehicle according to a place where the target vehicle is located and a destination;
acquiring position information of the target vehicle in real time; and
controlling lane indicating devices in the passing route to indicate a special-purpose lane used by the target vehicle in the passing route according to a real-time position information and the passing route of the target vehicle, and controlling traffic lights to indicate vehicles disturbing passing of the target vehicle to stop driving when the target vehicle passes through an intersection.

2. The rapid passing method for the target vehicle according to claim 1, wherein the controlling the lane indicating devices in the passing route to indicate the special-purpose lane used by the target vehicle in the passing route, comprises:
controlling a lane indicating device in each of road sections to work according to the real-time position information of the target vehicle and a traffic flow of each of the road sections in the passing route so as to indicate the special-purpose lane.

3. The rapid passing method for the target vehicle according to claim 2, wherein the controlling a lane indicating device in each of the road sections to work according to the real-time position information of the target vehicle and the traffic flow of each of the road sections in the passing route specifically, comprises:
determining arrival time when the target vehicle arrives at each of the road sections according to the real-time position information of the target vehicle;
determining guide time spent for clearing vehicles on the special-purpose lane in each of the road sections according to the traffic flow of each of the road sections in the passing route; and
controlling the lane indicating device in each of the road sections to start to work when a condition that t1+t3=t2 is met, wherein t1 represents for the guide time, t2 represents for the arrival time, and t3 represents for preset reserved time.

4. The rapid passing method for the target vehicle according to claim 1, wherein the controlling the traffic lights to indicate the vehicles disturbing the passing of the target vehicle to stop driving when the target vehicle passes through the intersection, comprises:
controlling the traffic lights in a traveling direction of the target vehicle to display one of a red light and a green light and controlling all traffic lights in a non-traveling direction of the target vehicle to display the red light when the target vehicle passes through the intersection to go straight.

5. The rapid passing method for the target vehicle according to claim 1, wherein the controlling the traffic lights to indicate the vehicles disturbing the passing of the target vehicle to stop driving when the target vehicle passes through the intersection, comprises:
controlling each of the traffic lights in the intersection to display a red light when the target vehicle passes through the intersection to turn left or right.

6. The rapid passing method for the target vehicle according to claim 1, when controlling the lane indicating devices in the passing route to indicate the special-purpose lane used by the target vehicle in the passing route, the method further comprising:
controlling the lane indicating devices in the passing route to indicate applications of all driving lanes except the special-purpose lane used in the passing route.

7. The rapid passing method for the target vehicle according to 1 claim 1, wherein the lane indicating devices comprise a voice unit; and the controlling the lane indicating devices in the passing route to indicate the special-purpose lane used by the target vehicle in the passing route, comprises:
controlling the voice unit in the lane indicating devices in the passing route to perform voice broadcasting on the special-purpose lane used by the target vehicle in the passing route.

8. The rapid passing method for the target vehicle according to claim 7, when controlling the voice unit in the lane indicating devices in the passing route to perform voice broadcasting on the special-purpose lane used by the target vehicle in the passing route, the method further comprising:
controlling the voice unit in the lane indicating devices in the passing route to perform voice broadcasting on the applications of all the driving lanes except the special-purpose lane used in the passing route.

9. The rapid passing method for the target vehicle according to claim 1, wherein the lane indicating devices comprise a display unit; and the controlling the lane indicating devices in the passing route to indicate the special-purpose lane used by the target vehicle in the passing route, comprises:
controlling the display unit in the lane indicating devices in the passing route to display the special-purpose lane used by the target vehicle in the passing route.

10. The rapid passing method for the target vehicle according to claim 9, when controlling the display unit in the lane indicating devices in the passing route to display the special-purpose lane used by the target vehicle in the passing route, the method further comprising:
controlling the display unit in the lane indicating devices in the passing route to display the applications of all the driving lanes except the special-purpose lane used in the passing route.

11. The rapid passing method for the target vehicle according to claim 1, wherein the special-purpose lane is a driving lane with a same application in each of the road sections of the passing route.

12. The rapid passing method for the target vehicle according to claim 11, wherein the driving lane comprises a left-turn lane, a right-turn lane and a straight lane.

13. The rapid passing method for the target vehicle according to claim 1, wherein the determining the passing route of the target vehicle, comprises:
determining a passing route by which a driving time of the target vehicle is shortest according to the place where the target vehicle is located and the destination in combination with road condition information.

14. The rapid passing method for the target vehicle according claim 1, wherein the target vehicle comprises at least one of an ambulance, a fire engine or a police car.

15. (canceled)

16. A central control system, comprising a memory, a processor and a computer program stored in the memory and capable of operating on the processor, wherein the processor is configured to execute the computer program to perform the rapid passing method for the target vehicle according to claim 1.

17. A rapid passing device for a target vehicle, comprising:
traffic lights;
the central control system according to claim 16; and
a lane indicating device configured to indicate a special-purpose lane used by the target vehicle in a passing route.

18. The rapid passing device for the target vehicle according to claim 17, wherein the lane indicating device comprises a display unit configured to display the special-purpose lane used by the target vehicle in the passing route.

19. The rapid passing device for the target vehicle according to claim 18, wherein the display unit comprises a plurality of display screens, wherein one of the display screens corresponds to one lane in a road section.

20. The rapid passing device for the target vehicle according to claim 17, wherein the lane indicating device comprises a voice unit configured to perform voice broadcasting on the special-purpose lane used by the target vehicle in the passing route.

21. The rapid passing device for the target vehicle according to 20 claim 17, wherein each of the traffic lights is integrally provided with the lane indicating device.
